(19) United States
(12) Patent Application Publication
(10) Pub. No.: US 2002/0139258 A1
(43) Pub. Date: Oct. 3, 2002

(54) Proofing attachment for registering screen frames with printing machine arms

(76) Inventor: Alan J. Hamu, Sunset Beach, CA (US)

Correspondence Address: Boniard I. Brown, 1500 West Covina Parkway, #113, West Covina, CA, 91790-2793, US

(21) Appl. No.: 10/113,227

(22) Filed: Mar. 29, 2002

Related U.S. Application Data
(60) Provisional application No. 60/279,943, filed on Mar. 30, 2001.

(51) Int. Cl. B41F 13/02

(52) U.S. Cl. 101/127.1

(57) ABSTRACT

A proofing attachment for registration of screen frames relative to radial arms of a printing machine has a plurality of clamps to urge successive screen frames into abutment with stops to register the screen frames with the arms.

### RELATED APPLICATIONS

Reference is made to my Provisional Application No. 60/279,943, filed Mar. 30, 2001.

### BACKGROUND AND SUMMARY OF THE INVENTION

The present invention relates to silk-screen processes, and to the registration in printing machines of a plurality of silk-screen frames.

In silk-screen printing, each of a plurality of screen frames, each bearing a workpiece such as a T-shirt, has applied thereto successive different colors of a pattern. Generally the printing machines are of a carousel-type, wherein each frame is mounted on an outwardly extending radial arm of the machine.

Conventional screen frame printing machines mount a plurality of screen frames, each disposed on a radially extending arm and rotatable about an axis of rotation. A plurality of pallets, each carrying an item to be imprinted, such as a T-shirt, are disposed on radially extending arms beneath the screen frame arms, and extending from a central member, and are rotatably positionable beneath the screen frames.

Each silk-screen frame must be in accurate registration with its machine arm and relative to other screen frames on other arms. Substantial personnel time and effort have been required to establish accurate registration of the screen frames relative to each other in order to achieve accurate registration of successive imprinting of color patterns on the workpiece of each screen frame.

The present invention provides a proofing attachment which is mounted in the same position and by the same clamping the arms of a machine. The screen attachment is mounted at a single station.

The proofing attachment accommodates the installation therein of an individual screen frame and the accurate positioning of the attachment by registration blocks on the attachment which provide accurate three-poing positioning and registration of the screen frame by means of spring clamps which urge the screen frame members against the blocks in a three-point registration arrangement.

In conducting a test or proofing run, each of the plurality of screen frames is successively positioned in the attachment to apply a single imprint and/or color to each of the items on the pallets, which pallets are successively positioned under the screen frame mounted in the proofing attachment. This procedure is repeated for each successive screen frame mounted in the proofing attachment. That is, for each screen frame thus successively positioned for a particular color application, the pallets are successively positioned in the proofing attachment and the respective screen frame, thus to apply a succession of colors to the items disposed on the respective pallets.

The accurate registration of screen frames relative to its respective arm is provided quickly and effectively by the proofing attachment. The examination of the screen frames thus imprinted with the successive colors is examined, as by a customer, for approval.

### BRIEF DESCRIPTION OF THE DRAWINGS

FIG. 1 is a perspective view of a multi-station screen-printing machine whereon a proofing attachment of the invention is mounted;

FIG. 2 is a perspective view of a proofing attachment of the invention in relation to a plurality of silk-screen frames for successive mounting thereon;

FIG. 3 is a plan view of a proofing attachment of the invention with a screen frame mounted therein; and

FIG. 4 is an elevational view of a spring clamp assembly of a modified form of the invention.

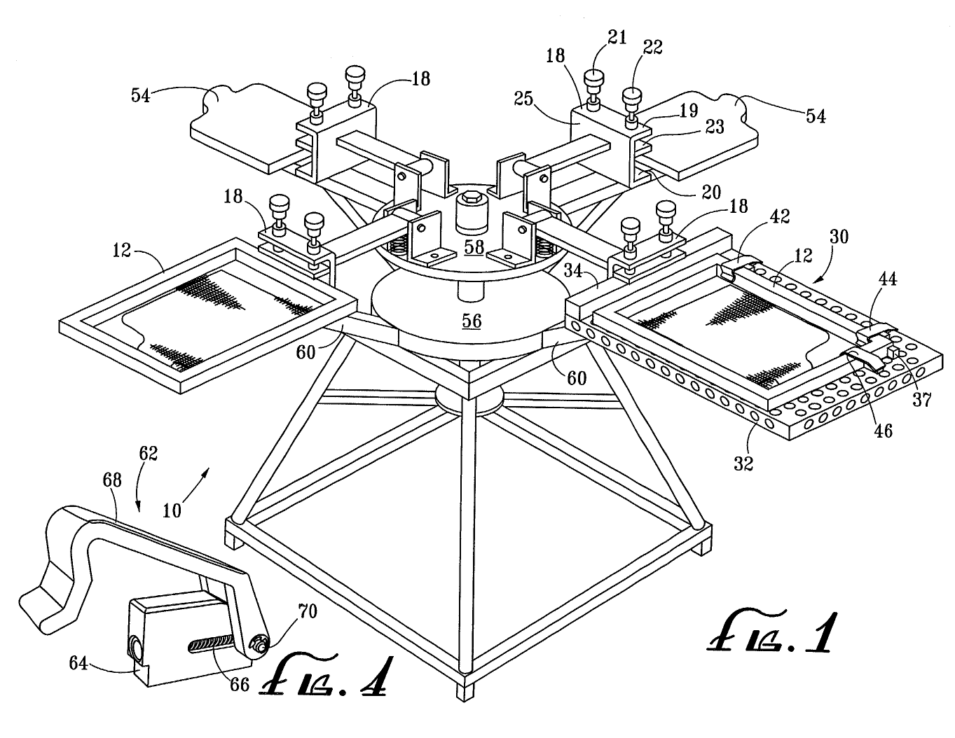

### DESCRIPTION OF THE PREFERRED EMBODIMENT

Referring to the drawings, a conventional textile silk-screen printing press 10 has a vertical axis about which a plurality of silk-screen printing frames are disposed radially outwardly and carry printing frames 12, 14, 16, 17. The printing frames are carried by respective support arms, which are pivotally mounted at their inner end portions, as shown, for limited upward and downward movement. Each silk-screen frame and clamping jaw is pivotal upwardly by spring action and movable downwardly during the operation of the machine.

Printing press or machine 10, and its arms arrangement, screen frames, and pallets arrangement are conventional, and are generally described in U.S. Pat. No. 5,694,845 to Newman. Other machines with greater numbers of printing frames, etc., may be utilized with the invention, such as large carousel machines with a large number of arms, screen frames, and pallets.

Each silk-screen frame is very accurately positioned and clamped in a clamping jaw 18 mounted on the end of a support arm. The frames are of rectangular configuration and are typically formed of wood or metal. An end frame portion of each frame is clamped between a clamping plate 23 and a lower leg 20 of the clamping jaw. Each clamping jaw 18 comprises an elongated generally C-shaped channel member which has upper and lower legs or walls 19, 20 joined by a transverse back wall 25, as shown. A pair of spaced-apart clamping screws 21, 22 extend threadedly through threaded openings in the clamping plate 23. The clamping jaws are secured by welding to respective support arms or are cast integrally with the respective arms. The screen frames may be permanently mounted on the end of the support arms, but typically are adjustably mounted and secured as above described.

Pallets 54 are mounted on a separate rotor 56 rotatable independently of the rotor 58 on which the screen frames are mounted. The pallets are mounted on respective arms 60 welded to the rotor 56 and extend radially therefrom. Each pallet has thereon an article (not shown), such as a t-shirt to be imprinted.

It is very important that each of the screen frame support assemblies be capable of accurately positioning each screen frame. This is accomplished by providing accurately-held tolerances in the mounting of all the support assemblies and screen frames for rotation about a single spindle axis.

A proofing attachment 30 according to the invention comprises an outer frame 32, typically of steel, having perforations therein for weight reduction, and adapted to be clamped by a clamping jaw mechanism 18, above described, relative to clamping screen-printing frames.

The proofing attachment or device 30 is accurately positionable in the same manner as for a screen printing frame, and is positioned and clamped in the machine in the same manner as a screen frame.

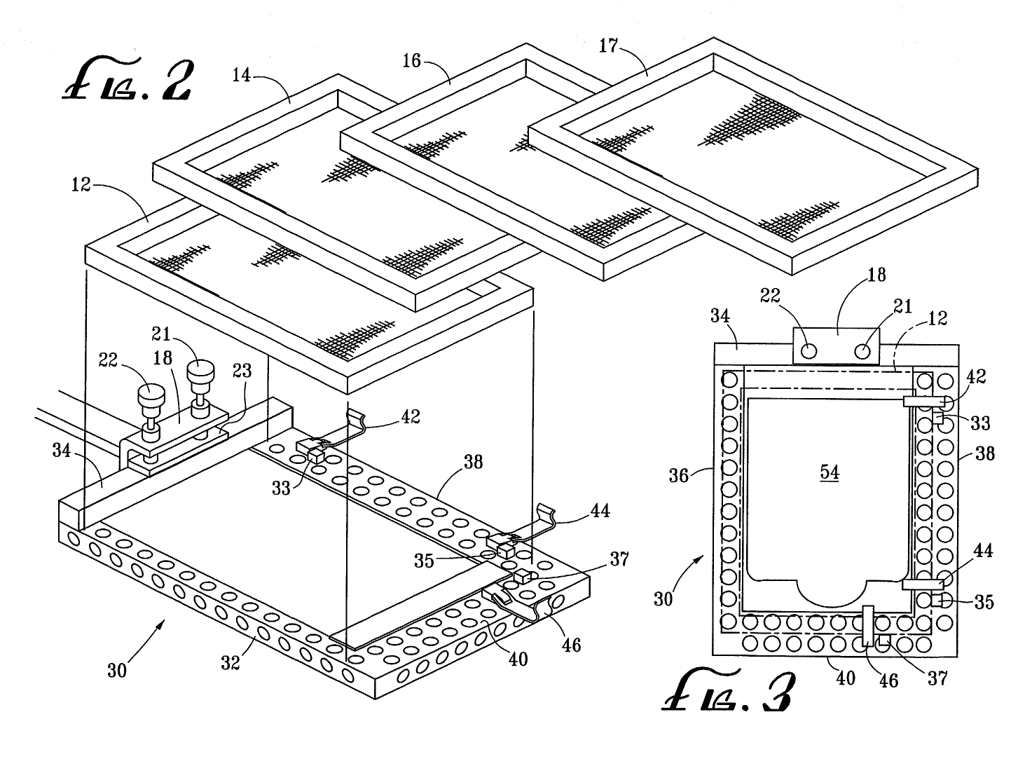

The proofing attachment has an upper member 34, side members 36, 38 (FIG. 3), and a lower member 40. On the upper surfaces of the members are accurately mounted registration blocks 33, 35, 37 positioned as shown, with two registration blocks on side member 38 and one on the frame end member 40, as shown.

In the preferred form of the invention shown in FIGS. 2 and 3, a screen frame 12, typically formed of wood or metal, is positioned in a space defined in the proofing attachment 30, as shown. Thus positioned, the screen frame is clamped in accurate position, with portions of the frame urged into contact with three registration blocks 33, 35, 37, by pivoting spring clamps 42, 44, 46 to resiliently clamp frame members in close contact with registration blocks 33, 35, 37, as indicated in FIG. 3. With the proofing attachment being in accurate registration with the machine arm relative to which it is clamped by clamp 18, the screen frame therein is placed in accurate registration relative to the support arm on which clamp 18 is mounted, and is therefore in registration with the radially extending arms of the carousel machine.

With the proofing attachment positioned only once in a clamp 18 on one arm of the carousel machine, each respective screen frame is accurately automatically registered with the machine arm relative to the arm on which it is to be mounted.

Each of a plurality of screen frames in succession, typically one screen frame for each arm of the carousel machine, is disposed in succession in the proofing attachment and is accurately positioned by the three-point positioning of each screen frame against the registration blocks. Each of a plurality of frames in succession is thus disposed in accurate registration by the registration blocks of the proofing attachment 18. Each successive screen frame it utilized for a respective color and/or image to be applied to a workpiece, such as a T-shirt.

FIG. 4 shows another form of clamp device 62 wherein a housing 64 is secured on the proofing attachment, as by threaded fasteners, and contains an helical spring 66. A spring clamp 68 is pivotally mounted on a pivot on a helical spring 66, the pivot being movable in a slot in a spring housing 64, as shown. The clamp 68 is thus movable further outwardly from the housing 64 by depression of the spring 66, thus to engage a relatively wide screen frame member.

A separate screen frame is utilized for each respective color and/or image to be imprinted and is positioned in succession by the plurality of stations being printed with successive images and/or colors.

Quick and effective screen frame alignment is provided for proofing and sampling purposes. Using only one shirt or item to be imprinted, and one screen frame at a time, this is accomplished without requiring up to an hour to align each frame with a machine arm, requiring a great deal of time for aligning of four, six, or eight screen frames, depending upon the number of screens utilized on particular carousel machines.

It will be understood that various changes and modifications may be made from the preferred embodiment discussed above without departing from the scope of the present invention.

The invention claims

1. A proofing attachment for accurate registration of a plurality of screen frames relative to radially extending arms of a carousel printing machine, the proofing attachment comprising:
the proofing attachment being adapted to be clamped like a screen frame on a radial arm of the carousel printing machine,
a plurality of stops on the proofing attachment to receive successive screen frames in abutting relation therewith to accurately position each screen frame both parallel to and perpendicular to the radial arm, whereby the screen frame is thus accurately positioned relative to the machine arm and is positioned relative to a plurality of screen arms extending radially of the machine, and
means for clamping successive screen frames against said stops of the proofing attachment,
whereby registration of successive screen frames by the proofing attachment effects accurate registration of each of the screen frames relative to respective machine arms on which the screen frames are mounted to enable successive imprints by successive screen frames on a workpiece with accurate registration of the successive imprints.

2. A proofing attachment according to claim 1, wherein each of the screen frames is rectangular in configuration.

3. A proofing attachment according to claim 1, wherein the proofing attachment defines a rectangular cavity adapted to receive a screen frame.

4. A proofing attachment according to claim 1, wherein said clamp means resiliently urges screen frame members into abutting relation with said stops.

5. A proofing attachment according to claim 1, wherein the attachment is clamped in a clamp of one of radially extending arms of the carousel machine.

6. A proofing attachment according to claim 1, wherein respective ones of a plurality of screen frames may be clamped on respective machine arms in accurate registration with each other.

7. A proofing attachment according to claim 6, wherein registration with the machine arm by the attachment effects registration of the screen frame with other machine arms.

8. A proofing attachment for accurate registration of a plurality of screen frames relative to radially extending arms of a carousel printing machine, the proofing attachment comprising:
the proofing attachment being adapted to be clamped like a screen frame on a radial arm of the carousel printing machine,
a plurality of stops on the proofing attachment to receive successive screen frames in abutting relation therewith to accurately position each screen frame both parallel to and perpendicular to the radial arm, whereby the screen frame is thus accurately positioned relative to the machine arm and is positioned relative to a plurality of screen arms extending radially of the machine,
said plurality of stops comprising three stops, one positioned to accurately position a frame perpendicular to the machine arm, and two stops to position a frame member parallel to the machine arm, and
a plurality of pivotally mounted clamps rotatable into clamping positions to urge screen frame members into abutment with said stops,
whereby registration of successive screen frames by the proofing attachment effects accurate registration of each of the screen frames relative to respective machine arms on which the screen frames are mounted to enable successive imprints by successive screen frames on a workpiece with accurate registration of the successive imprints.

9. A proofing attachment according to claim 8, wherein each of the screen frames is rectangular in configuration.

10. A proofing attachment according to claim 8, wherein the proofing attachment defines a rectangular cavity adapted to receive a screen frame.

11. A proofing attachment according to claim 8, wherein the attachment is clamped on one of a plurality of arms of the carousel machine.

12. A proofing attachment according to claim 8, wherein each of a plurality of radially extending machine arms carries each of the screen frames to successive rotational positions to apply an imprint via a silk-screen onto a workpiece at successive positions of rotation of machine arms to provide a composite imprint with respective imprints in accurate registration.

13. A proofing attachment for accurate registration of a plurality of screen frames relative to radially extending arms of a carousel printing machine, the proofing attachment comprising:
the proofing attachment being adapted to be clamped like a screen frame on a radial arm of the carousel printing machine,
a plurality of stops on the proofing attachment to receive successive screen frames in abutting relation therewith to accurately position each screen frame both parallel to and perpendicular to the radial arm, whereby the screen frame is thus accurately positioned relative to the machine arm and is positioned relative to a plurality of screen arms extending radially of the machine,
a plurality of pivotally mounted clamps rotatable into clamping positions to urge screen frame members into abutment with said stops,
whereby registration of successive screen frames by the proofing attachment effects accurate registration of each of the screen frames relative to respective machine arms on which the screen frames are mounted to enable successive imprints by successive screen frames on a workpiece with accurate registration of the successive imprints.

14. A proofing attachment according to claim 13, wherein each of the screen frames is rectangular in configuration.

15. A proofing attachment according to claim 13, wherein the proofing attachment defines a rectangular cavity adapted to receive a screen frame.

16. A proofing attachment according to claim 13, wherein the proofing attachment is clamped in one of a plurality of radially extending arms of the carousel machine.

17. A proofing attachment according to claim 13, wherein said respective ones of a plurality of screen frames may be clamped on respective machine arms in accurate registration with each other.

18. A proofing attachment according to claim 13, wherein each of a plurality of radially extending screen arms carries a screen frame to successive rotational positions to apply an imprint via a silk screen onto a workpiece, successive screen frames applying successive different imprints at successive positions of rotation of the arms to provide a composite imprint with respective imprints in accurate registration.
